(19) United States
(12) Patent Application Publication
(10) Pub. No.: US 2016/0223237 A1
(43) Pub. Date: Aug. 4, 2016

(54) USER INTERFACE FOR PREDICTIVE FAILURE ANALYSIS OF A COOLING DEVICE

(71) Applicant: Kaleb Zeringue, Jacksonville, FL (US)

(72) Inventor: Kaleb Zeringue, Jacksonville, FL (US)

(21) Appl. No.: 15/010,083

(22) Filed: Jan. 29, 2016

Related U.S. Application Data
(60) Provisional application No. 62/110,884, filed on Feb. 2, 2015.

(51) Int. Cl. F25B 49/00; G01M 99/00

(52) U.S. Cl. CPC F25B 49/005; G01M 99/005

(57) ABSTRACT

The present disclosure relates to methods and apparatus for viewing electronic information gathered and transmitted by a predictive failure device. More specifically, the present disclosure presents methods and apparatus for viewing processed data related to the performance of a cooling unit. In some embodiments, the predictive failure interfacing device may provide current and continuous data from a cooling device and/or components thereof to a user. In some aspects, the interface may further prompt and allow a user to request actions based on the predictive failure information.

### RELATED APPLICATIONS

This Patent Application claims the benefit of, and incorporates by reference as if set forth in full herein, U.S. Provisional Patent Application No. 62/110,884, filed on 2 Feb. 2015, titled USER INTERFACE FOR PREDICTIVE FAILURE ANALYSIS OF A COOLING DEVICE.

### FIELD OF THE DISCLOSURE

The present disclosure relate to methods and apparatus for viewing electronic information. More specifically, the present disclosure presents methods and apparatus for viewing processed data related to the performance of a cooling unit.

### BACKGROUND OF THE DISCLOSURE

Traditional methods of viewing performance data of cooling units is generally limited to digital and analog gauges which display information related to temperature of the interior of the cooling unit. Additional options which may create a more accurate view of the performance of the cooling unit has traditionally been limited to data logging and temperature alerts which may trigger when a unique condition is met.

Improvements in this design have been generally limited to increased accuracy across a broad range of temperatures or custom application or fabrication of probes for specific applications. Today, the use of industry benchmark temperature probes symbolizes the pinnacle in cooling unit reporting.

The application of software to monitor cooling units has traditionally been limited to temperature monitor display. Customization and improvement is limited to corporate logos, process control numbers on output forms or data sheets, and automated reporting for regulators or quality control.

The problem with this arrangement is the information display is critically limited by the amount and type of information which may be displayed.

### SUMMARY OF THE DISCLOSURE

What is needed is a display method and apparatus which provides the user with meaningful data computed and organized in a meaningful manner to the user. Accordingly, the present invention provides methods and apparatus for providing a viewer with individualized and comprehensive data based upon a user's location and cooling unit needs.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary embodiment of a single screen graphical user interface (GUI).

FIG. 2 illustrates an exemplary embodiment of a single screen graphical user interface (GUI).

FIG. 3 illustrates an exemplary embodiment of a single screen graphical user interface for the user to receive instructions.

FIG. 4 illustrates a block diagram for data delivery according to same embodiments of the present invention.

FIG. 5 illustrates an exemplary processing and interface system.

### DETAILED DESCRIPTION

The present disclosure provides generally for the display of data. According to the present disclosure, a user is provided with the capability to view raw and processed data relating to performance metrics of a cooling unit. The user may, through viewing the data, be provided with the ability to determine the historic performance, the current performance, and probable future performance of the cooling unit. In addition, in some embodiments, the present enclosure includes notifications of an automated service dispatch or an alert for foe user to notify a service person. In some other embodiments, the user may be given information to perform a service to the unit.

In the following sections, detailed descriptions of examples and methods of the disclosure will be given. The description of both preferred and alternative examples though through are exemplary only, and it is understood that to those skilled in the art that variations, modifications, and alterations may be apparent. It is therefore to be understood that the examples do not limit the broadness of the aspects of the underlying disclosure as defined by the claims.

### GLOSSARY

Predictive Failure Device: as used herein refers to a device that may actively predict failure of a cooling device, such as a refrigerator or freezer. In some embodiments, the predictive failure device may comprise one or more a monitoring mechanism, analyzing mechanism, and measuring mechanism, wherein the mechanisms may manage data acquired from the cooling device. In some embodiments, the management of the data may allow the predictive failure device to actively track, the efficiency and/or operational quality of the cooling device and/or its components. In some embodiments, the data may comprise the electrical usage of a cooling unit.
Performance Information: as used herein refers to accumulated data that may be processed to assess the performance of a cooling unit.
Performance Profile: as used herein refers to performance information and other data used to create an expected range of performance under set circumstances for a cooling unit.

In some aspects, a predictive failure device may be integrated into or attached to a cooling device, such as a freezer or refrigerator. The predictive failure device may monitor the cooling device or components thereof. In some embodiments, the predictive failure device may comprise a monitoring mechanism, which may be programmed to monitor a predefined quality set. The predefined quality set may comprise characteristics of one or more the cooling device or a component within the cooling device, wherein the characteristics may be indicative of the effectiveness and/or efficiency of one or more the cooling device or a component within the cooling device. In some aspects, the predefined quality set may comprise one or more of current, temperature within the cooling device, temperature of one or more electrical components, electricity usage.

In some implementations, the monitoring mechanism may receive data regarding the predefined quality and may detect fluctuations that may indicate a decrease in effectiveness and/or efficiency, which may lead to a failure of the cooling device and/or a component of the cooling device. In some embodiments, the predictive failure device may further comprise an analyzing mechanism, which may analyze the monitored data, wherein the analysis may assess and/or quantify the effectiveness and/or efficiency. The analysis may further predict when the cooling device or the component may fail if so adjustments or repairs are made. In some aspects, the monitored data may be transmitted to an external device, which may execute the analysis.

In some aspects, the results may be transmitted to an external server, which may be accessed by a user, such as a restaurant owner, freezer repairman, or manufacturer. In some embodiments, emergency situations may be transmitted directly to a network device, such as a smartphone or tablet. In some aspects, some circumstances may prompt an action, such as “shut down cooling device” or “adjust settings” or “request repairs.”

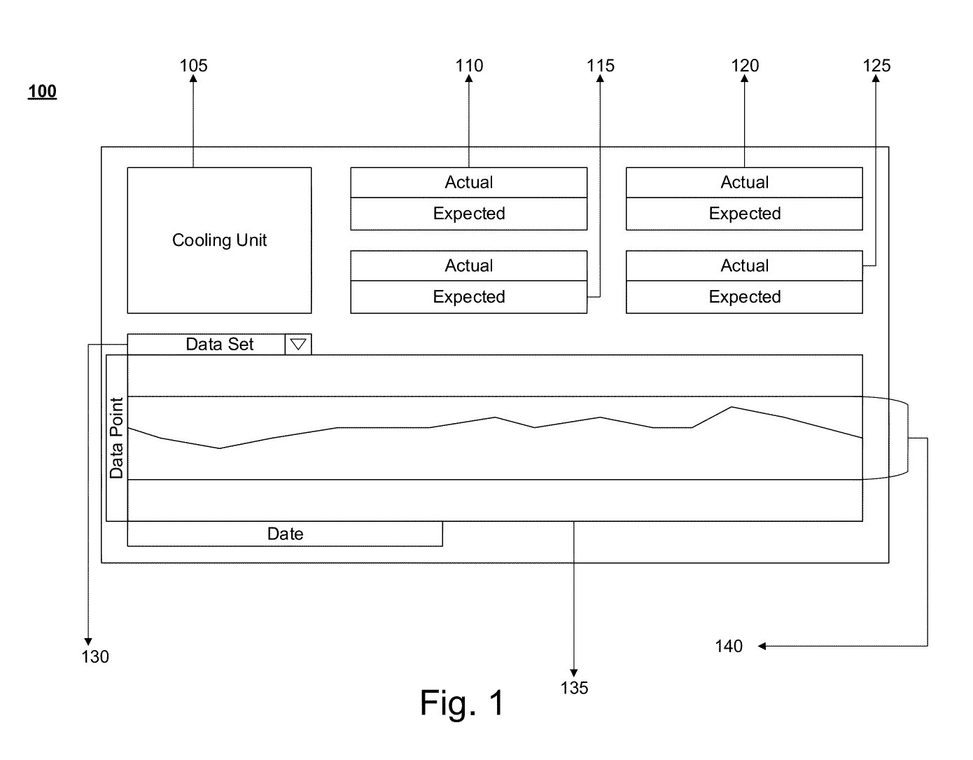

Referring now to FIG. 1, an exemplary embodiment of a graphical user interface (GUI) is illustrated. In some embodiments, cooling unit 105 may be displayed to notify the user of the specific cooling unit the display is showing data for. In some embodiments, the cooling unit 105 may allow a user to swipe a unit left or right to select between multiple cooling units. In some embodiments, the cooling unit 105 may allow a user to swipe left or right to select between multiple locations that have cooling units. In some embodiments, cooling unit 105 may allow a user to swipe left or right to select between multiple locations within a cooling unit. The control layout for cooling unit 105 may also be manipulated by a drop down menu, a series of smaller toggle buttons, or other method to control which specific data is to be shown.

In some embodiments, real time data display groups 110, 115, 120, and 125 may show the user data information about performance characteristics of the cooling unit in some embodiments, real time data may displayed. In some embodiments real time data may be displayed as well as a comparison data point. Comparison data points may include optimal performance, historic data points, average performance data points, and other data points which may provide useful information to the user. In some other embodiments real time data may be displayed as well as a maximum and minimum data point for a specific period of time such a calendar day.

In some embodiments, a visual data representation 135 may show multiple data points in a graphical style. In some embodiments, this may include a historic performance chart of a data set. An expected operating range 140, may show the preferred range which a data point should fall into. In some embodiments at 140, this range may be colored. In some embodiments, the range outside 140 may be colored red, orange, yellow, or any combination of the three to visually alert the user to the negative data point. In some implementations the visual data representation may be an active chart which plots data for a shorter period of time.

In some embodiments, a navigation system 130 may allow the user to navigate between different visual data depictions. An example of 130 would be a drop down menu where the user can view historical data of metrics from 110, 115, 120, and 125. In some embodiments, 130 may have additional options or may not include metrics from 110, 115, 120, and 125. In some embodiments, 130 may be a series of toggle buttons, tabs, or other method to select which visual data depletion is displayed.

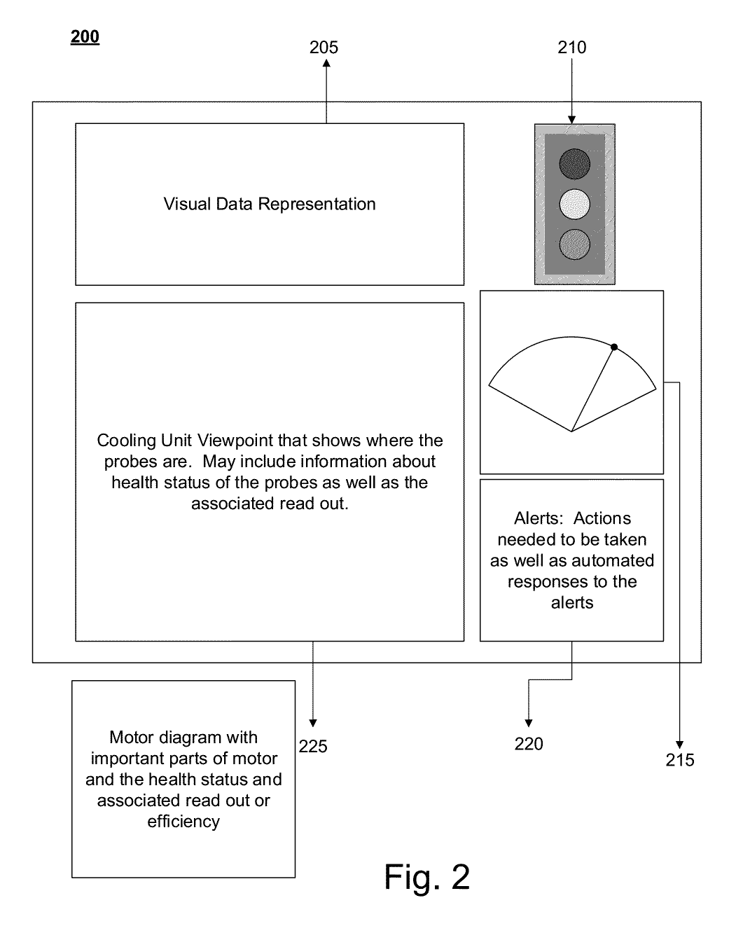

Referring now to FIG. 2, an exemplary embodiment of a graphical user interface (GUI) is illustrated. In contrast to the GUI 100 illustrated in FIG. 1, a visual data display GUI 200 may allow a user to view data points primarily by graphical depiction.

In some embodiments, visual data representation 205 may show multiple data points in a graphical style. In some embodiments, this may include a historic performance chart of a data set.

In some embodiments, system status 210 may show an overall performance of the system status. In some embodiments this may include a graphic to show the current status as well as any alerts. As an example, a graphical system status may include a graphic of a stop light. When the system is performing as expected and all suggested maintenance is up to date, the stop light may display green. However, if the unit has missed a scheduled maintenance or for a different reason the needs to alert the user a caution sign may appear as well. If the caution sign is ignored for a period of time, the stop-light may change to yellow. If the unit is not working the stop-light may be red. In some embodiments, this display may also include important sensor information.

In some embodiments, motor data graphic 215 may show the health status or operational efficiency of the motor. In some embodiments, this may be a visual scale read out. In some other embodiments this may be a percentage. In some other embodiments the motor data graphic may be a diagram or visual representation of a motor with the associated performance of the parts of the motor.

In some embodiments, alert notification box 220 may show important notifications. In some embodiments this may be information related to a service person. For example, a notification of the service person's name and picture may appear to alert the user and prevent unauthorized access to restricted areas. In some other embodiments alerts may be related to malfunctioning sensors, cooling unit access doors being left open, or any other important notification the user may find.

In some embodiments, cooling unit display 225 may show a graphical depiction of the cooling unit. In some embodiments, this may include a visual depletion of the cooling unit's floor plan and the location of sensors within the cooling unit. In some alternative examples the visual depiction of be cooling unit may be from a three dimensional perspective. In some embodiments, each depleted sensor location may also show the associated sensor data and the performance status of the sensor.

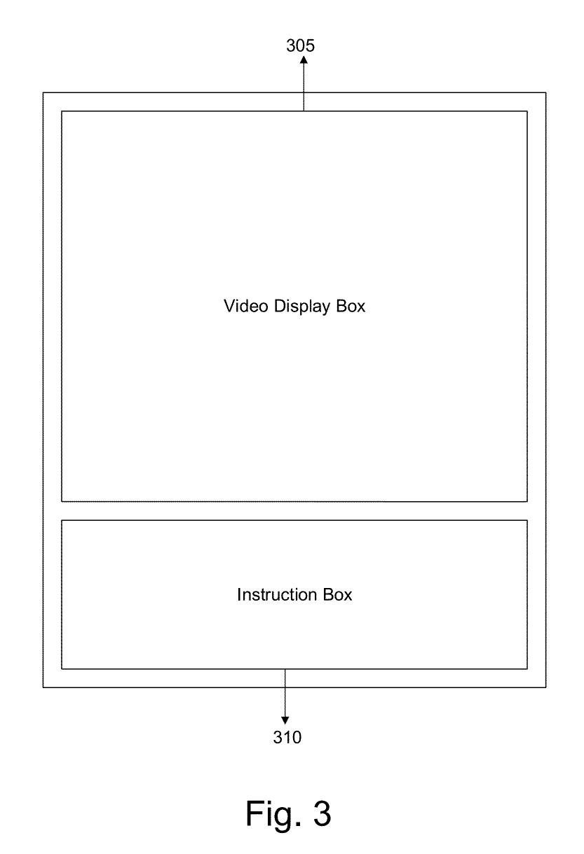

Referring now to FIG. 3, an exemplary embodiment of a single screen graphical user interface for the user to receive instructions is illustrated. In some embodiments, video display box 305 may show a user visual step by step instructions on how to repair or remedy a cooling unit failure. In some embodiments, the display may first alert the user and then display video on how to remedy the alert.

In some embodiments, instruction box 310 may display text instructions to guide the user in addressing an alert. In some embodiments 310 may be used synchronously with 305. In some other embodiments, 310 may provide information separate from 305.

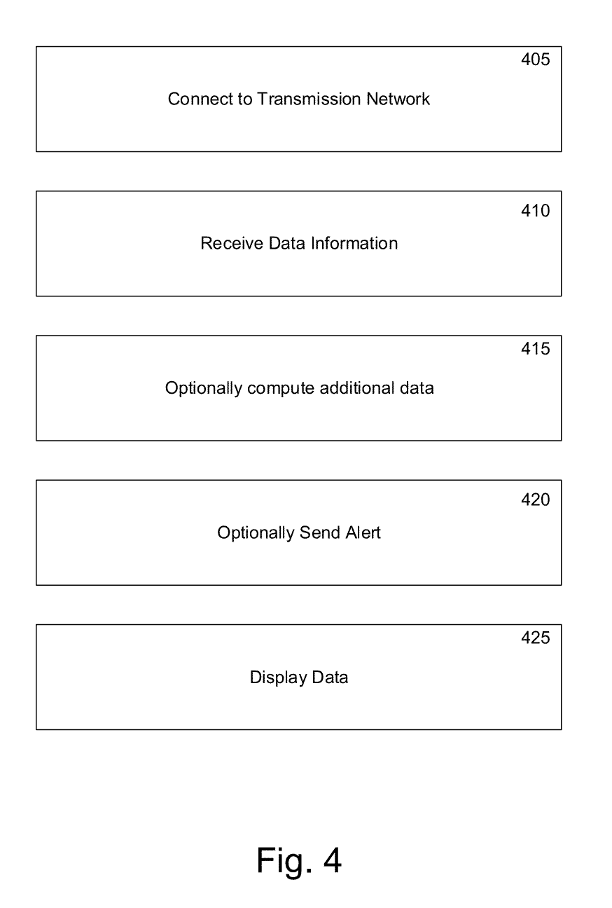

Referring now to FIG. 4, exemplary method steps for receiving and displaying data from an external device, such as a predictive failure device, are illustrated. At 405, a user interface may connect to a transmission network. At 410, data information may be received from an external device, such as a predictive failure device, via the transmission network. In some embodiments, at 415, additional data may be further computed.

For example, predictive failure data may comprise bulk information regarding a particular cooling device, and the predictive failure data may be further filtered at 415 for a particular user. Similarly, the predictive failure data of a particular cooling device may be compared to predictive failure data of other cooling devices, such as other of a specified brand or others within the same restaurant chain.

In some embodiments, at 420, alerts may be sent based on predetermined thresholds, such as predictive failure data that may prompt emergency or immediate action. At 425, data may be displayed, and in some embodiments, the display may be customized based on the end user's preferences or roles.

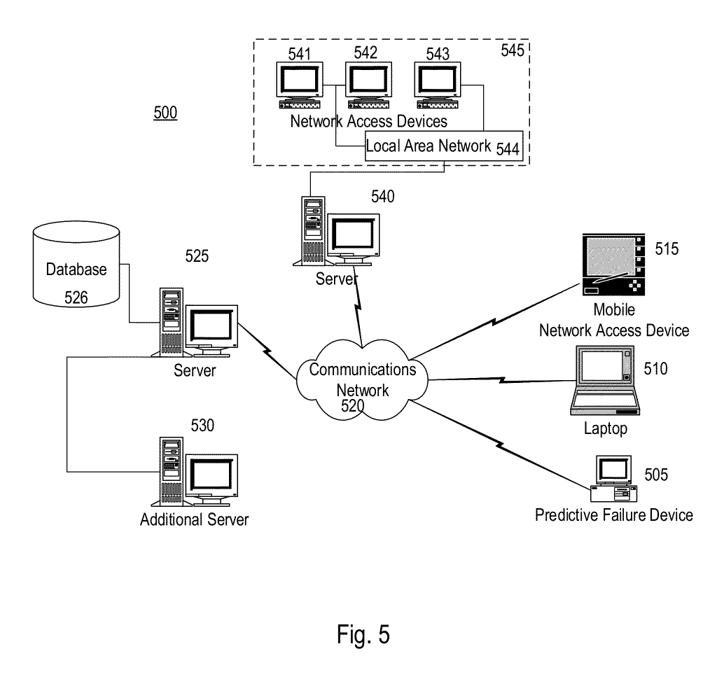

Referring now to FIG. 5, an exemplary processing and interface system 500 is illustrated. In some aspects, access devices 515, 510, 505, such as a predictive failure device 505, a mobile device 515 or laptop computer 510 may be able to communicate with an external server 525 though a communications network 520. The external server 525 may be in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such as PayPal or a social network, such as Facebook or a dating website.

### CONCLUSION

A number of embodiments of the present disclosure have been described. While tins specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or mote features from a claimed combination can in some eases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system, components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted In the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A predictive failure device interface for a cooling apparatus comprising:
a communications network access device configured to access a server in logical communication with a digital communications network; and
executable software stored on the communications network access device and executable on demand, the software operative with the communications network access device to cause the network access device to:
receive data for a predefined quality set from a predictive failure device, wherein the predictive failure device comprises a monitoring mechanism configured to monitor the predefined quality set of the cooling apparatus, wherein the predefined quality set comprises characteristics indicative of an effectiveness of at least one component of the cooling apparatus; and
provide data for the predefined quality set.

2. The predictive failure device interface of claim 1, wherein the network access device is further caused to:
analyze the data, wherein the analysis determines the effectiveness of the at least one component of the cooling apparatus;
provide the analysis; and
transmit the analysis to an external storage device.

3. The predictive failure device interface of claim 2, wherein the network access device is further caused to:
prompt a requested action in response to the analysis;
receive the requested action; and
transmit the requested action to an external device, wherein the external device is configured to execute the requested action.
